(19) United States
(12) Patent Application Publication
(10) Pub. No.: US 2026/0065154 A1
(43) Pub. Date: Mar. 5, 2026

(54) THREE-STAGE SEMI-SUPERVISED INSTANCE SEGMENTATION TRAINING METHOD AND SYSTEM

(71) Applicant: LITE-ON TECHNOLOGY CORPORATION, TAIPEI CITY (TW)

(72) Inventors: Jiun-In Guo, Hsinchu City (TW); Hua-Ren Liao, Hsinchu City (TW); CHIH-YUAN CHUANG, TAIPEI CITY (TW); JIUN-SHIUNG CHEN, TAIPEI CITY (TW)

(21) Appl. No.: 19/264,828

(22) Filed: Jul. 9, 2025

Related U.S. Application Data
(60) Provisional application No. 63/690,344, filed on Sep. 4, 2024.

(30) Foreign Application Priority Data
Jan. 22, 2025 (CN) 202510099258.X

(51) Int. Cl. G06N 20/00

(52) U.S. Cl. CPC G06N 20/00

(57) ABSTRACT

A three-stage semi-supervised instance segmentation training method and a system. In a first stage, a teacher model and a student model are trained based on labeled data. In a second stage, the teacher model performs prediction on unlabeled data and generates pseudo labels according to a prediction result. The student model learns labeled data and unlabeled data based on the pseudo labels. A soft label filter is used to filter for obtaining high-quality pseudo labels, a positive sample loss function is used to eliminate a problem of incorrect model convergence due to the pseudo labels with incomplete information, and the parameters of the student model are updated via a backward propagation process. In a third stage, the parameters of the student model are transferred to the teacher model through an exponential moving average operation, so that the teacher model and the student model are under a same architecture.

### CROSS-REFERENCE TO RELATED PATENT APPLICATION

This application claims the benefit of priority to China Patent Application No. 202510099258.X, filed on Jan. 22, 2025, in the People's Republic of China. The entire content of the above identified application is incorporated herein by reference.

This application claims the benefit of priority to the U.S. Provisional Patent Application Ser. No. 63/690,344, filed on Sep. 4, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a semi-supervised multi-stage mutual learning model, and more particularly to a three-stage semi-supervised instance segmentation training method and a system thereof that employ unlabeled data to enhance precision of a model so as to improve an existing semi-supervised learning method.

### BACKGROUND OF THE DISCLOSURE

An architecture using a teacher model and a student model is widely adopted by a conventional semi-supervised learning method. Updating the teacher model usually relies on an exponential moving average method to achieve a stable training result, since the method makes parameters of the teacher model gradually approach the parameters of the student model.

However, flexibility and innovation of the model will be limited since the conventional semi-supervised learning process requires the architecture of the teacher model to be consistent with the architecture of the student model. Improvement of performance of the model is limited because the conventional semi-supervised learning process cannot work with different training methods or under different model architectures. In other words, the effect of the model in a practical application is limited since it can be difficult to fully utilize advantages across various technologies to achieve an optimal performance.

The conventional instance segmentation technology requires a lot of time and human resources to obtain accurate labels. Further, since a model training process for the instance segmentation technology highly relies on a quality of labeled data, any tiny error in a data labeling process may cause significant impact on performance of a final model. Therefore, for ensuring the training effect, the model training process usually requires a very high quantity of the labeled data, which not only greatly increases training costs, but also prolongs a development cycle of the model. A large-scale application of the instance segmentation technology also faces a huge challenge when the scale of dataset is expanded, and time and cost required for manually labeling the data increases exponentially.

Still further, most of the current semi-supervised learning methods focus on fields of object detection and classification, and these technologies obtain good results in relatively simple tasks. However, the instance segmentation technology requires higher precision of pseudo labels because it is required to classify each of the pixels more precisely, such that it also becomes more difficult to train the instance segmentation model with the semi-supervised learning method. Inaccurate labeling results in problems that errors of the pseudo labels easily cause a significant decline in model performance, especially under diverse scenes and complex backgrounds. The above-described technical challenges have historically slowed down development of the semi-supervised instance segmentation technology.

Moreover, the current semi-supervised learning method generally relies on a fixed and higher threshold to generate effective pseudo labels. Although the high-threshold strategy can ideally filter out low-quality labels for increasing accuracy of training data, the quantity of unlabeled data is generally limited in an actual application, and the higher threshold will cause a large amount of unlabeled data to be abandoned. Therefore, this strategy not only wastes potential data resources, but also limits a learning scope and capability of the model. A final model performance may be affected because the learning capability of the semi-supervised learning method cannot be utilized in full capacity when the model is used for processing the diverse and complex dataset in the high-threshold strategy.

### SUMMARY OF THE DISCLOSURE

In response to the above-referenced technical inadequacies and for a purpose of effectively applying unlabeled data and generating high-quality pseudo labels in a semi-supervised learning method, provided in the present disclosure is a three-stage semi-supervised instance segmentation training method and a system.

In one of the embodiments of the three-stage semi-supervised instance segmentation training method, at a first stage, the teacher model and the student model are trained through labeled data until both the teacher model and the student model are in a stable state.

Next, at a second stage, the teacher model conducts prediction on the unlabeled data, assigns pseudo labels to the unlabeled data based on confidences of a prediction result, and provides the unlabeled data to the student model. The student model can not only learn the labeled data, but also learn the unlabeled data based on the pseudo labels. Moreover, in one aspect, a soft label filter is used to filter for obtaining high-quality pseudo labels, and uses a positive sample loss function to eliminate a problem of incorrect model convergence due to the pseudo labels with incomplete information. After that, the student model can be updated according to errors calculated by the positive sample losses through a backward propagation process.

In the third stage, the parameters of the student model are updated to the teacher model, and both the teacher model and the student model are operated under the same architecture.

Further, the parameters of the student model denote the weights operating the model. An exponential moving average operation is incorporated to update the student model to be the teacher model through the weights that are obtained through a learning method.

Still further, the positive sample loss function is performed to calculate the positive sample losses with respect to the labeled data and the unlabeled data that are classified from the received data. Negative impact can be reduced by learning from positive samples, and the problem of incorrect model convergence due to the pseudo labels with incomplete information can be eliminated.

Further, when the pseudo labels are generated, the soft label filter is used to assign a first weight to the data with the pseudo labels having the confidences greater than a first threshold, assign a second weight to the data with the pseudo labels having the confidences between the first threshold and a second threshold, and discard the data with the pseudo labels having the confidences less than the second threshold.

In the above first stage and the second stage, according to a scaling training strategy, the teacher model learns high-resolution pictures so as to generate reliable pseudo labels.

In an aspect, the system adopts asymmetric teacher-student model architecture that allows the teacher model and the student model to use the intelligent model having the same model types but with different precisions.

Further, when training the teacher model, a weak data augmented strategy is incorporated to learn images that are not substantially changed. On the other hand, when training the student model, a strong data augmented strategy is incorporated to learn images that are significantly changed. A purpose of this approach is to make a final performance of the student model greater than the teacher model.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a system framework that operates a three-stage semi-supervised instance segmentation training method according to one embodiment of the present disclosure;

FIG. 2 is a flowchart illustrating the three-stage semi-supervised instance segmentation training method according to one embodiment of the present disclosure;

FIG. 3 is a flowchart illustrating a first stage operating process of the three-stage semi-supervised instance segmentation training method according to one embodiment of the present disclosure;

FIG. 4 is a flowchart illustrating a second stage operating process of the three-stage semi-supervised instance segmentation training method according to one embodiment of the present disclosure;

FIG. 5 is a flowchart illustrating a third stage operating process of the three-stage semi-supervised instance segmentation training method according to one embodiment of the present disclosure;

FIG. 6 is a schematic diagram depicting operation of a positive sample loss module in the three-stage semi-supervised instance segmentation training method according to one embodiment of the present disclosure;

FIG. 7 is a flowchart illustrating the three-stage semi-supervised instance segmentation training method according to one embodiment of the present disclosure; and

FIG. 8 is a flowchart illustrating a process of filtering out pseudo labels in the three-stage semi-supervised instance segmentation training method according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a three-stage semi-supervised instance segmentation training method and a system that operates the method. The method is used to train a model that is used to label objects in an environmental image. The three-stage semi-supervised instance segmentation training method is configured to integrate the technologies under different model architectures and with different data augmentation strategies. The training method applies a small amount of labeled data and unlabeled data and uses a refined teacher model as a guide to enhance accuracy of mask prediction, by which a convolutional neural network (CNN) framework deep-learning model (e.g., YOLOv8) can be trained.

In the method, accuracy of model recognition can be enhanced by incorporating the unlabeled data and improving learning capacity of the model (i.e., model complexity), which means that the more complex teacher model is improved in the method for improving the learning capacity of the teacher model so as to achieve a training effect such as enhancing the semi-supervised instance segmentation model.

In a general semi-supervised learning method, a target model is trained by using the labeled data in the training process and based on the pseudo labels for the unlabeled data generated by a well-trained model. One of the objectives to use the pseudo labels is to predict and label the unlabeled data, and the unlabeled data is combined with the original labeled data for improving performance of the model that is trained through these data.

For quickly obtaining a large amount of labeled data for training the target model, the refined teacher model is provided. The refined teacher model uses a more complex and stronger model to generate the pseudo labels, and adopts a soft label filter to select credible pseudo labels. Further, for training a strong instance segmentation model in order to obtain the target model, a specific algorithm is provided in the three-stage semi-supervised instance segmentation training method of the present disclosure. In the algorithm, the labeled data are firstly used to train a baseline model. The baseline model conducts prediction on the unlabeled data and assigns the pseudo labels to the unlabeled data with the highest probability in each of prediction results. Therefore, a large amount of pseudo labels are generated by the baseline model. After that, the labeled data can be combined with the unlabeled data with the pseudo labels for the purpose of enhancing the recognition accuracy of the model.

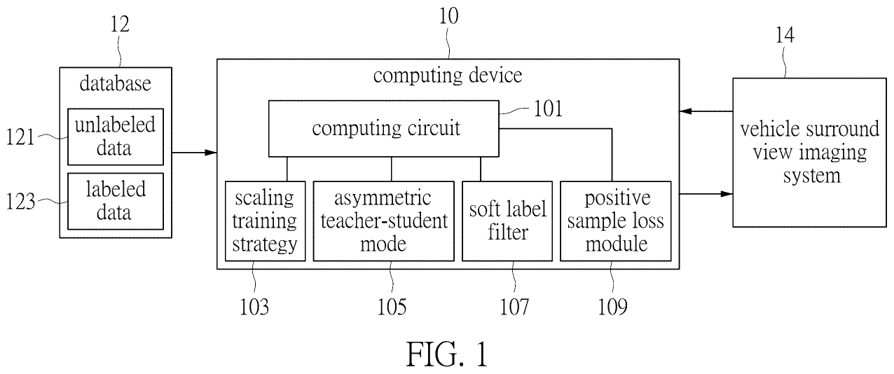

The system operating the three-stage semi-supervised instance segmentation training method is under a framework including a computing device and a database. Reference is made to FIG. 1, which is a schematic diagram illustrating the system framework according to one embodiment of the present disclosure.

The system includes a computing device 10 that is used to conduct computation and a database 12 that is used to store unlabeled data 121 and labeled data 123. The computing device 10 is in a form of a computer host or a server. The computing device 10 operates various software modules in the three-stage semi-supervised instance segmentation training method through collaboration of a computing circuit 101 (e.g., one or more processors) and software means. The software modules are such as a scaling training strategy 103, an asymmetric teacher-student model 105, a soft label filter 107 and a positive sample loss module 109.

When the system operates the three-stage semi-supervised instance segmentation training method, a high-performance model can be trained by the unlabeled data 121 and the labeled data 123. In certain embodiments of the present disclosure, the soft label filter 107 and a positive sample loss function performed in the positive sample loss module 109 can be used in the training method for training the high-performance model under the asymmetric teacher-student model architecture. In particular, in one of the applicable fields, the high-performance model obtained by the training method can process a higher resolution image more efficiently, for example, the model can be applied to a vehicle surround view imaging system 14. The vehicle surrounding view imaging system 14 is installed in a vehicle or various moving carriers and is connected with the local or remote computing device 10. In one of the embodiments of the present disclosure, a large amount of high-resolution images that are generated in real time are transmitted to the remote computing device 10 via a network. For accurately detecting and classifying objects around the vehicle (e.g., the other vehicles around the vehicle) from a real-time surround view of the vehicle, the three-stage semi-supervised instance segmentation training method performed in the computing device 10 can be used to train the high-performance model. The high-performance model helps a driver to control an overall road condition for avoiding blind spots and enhancing safety.

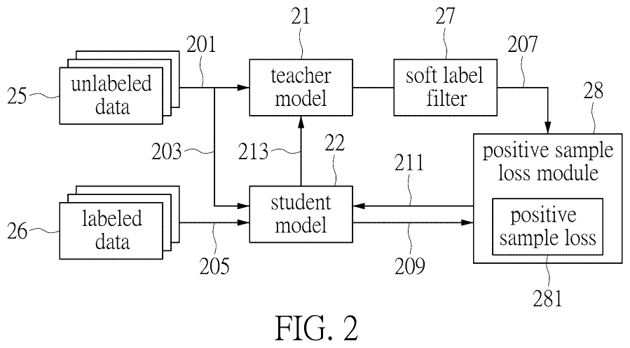

Reference is next made to FIG. 2, which is a schematic diagram illustrating a system framework operating the three-stage semi-supervised instance segmentation training method according to one embodiment of the present disclosure.

The system that operates the training method separates the semi-supervised learning method into a teacher model 21 and a student model 22. The teacher model 21 is responsible for generating pseudo labels that are used to guide the student model 22. The training method adopts a data augmentation strategy different from the student model 22 when the teacher model 21 is trained. The system allows the refined teacher model in the same framework to learn more details by enhancing resolution of input data and generate better quality pseudo labels.

According to the embodiment shown in the diagram, when applying the unlabeled data 25, the teacher model 21 uses a weak data augmented strategy (201) and the student model 22 uses a strong data augmented strategy (203). The weak data augmented strategy (201) will not substantially change the original data, and therefore the teacher model 21 performs prediction on the unlabeled data 25 and generates the pseudo labels with high credibility according to prediction results with high confidences. Taking image processing as an example, the strong data and the weak data can respectively be used to indicate whether or not the image features are significantly changed. For example, the data that is changed through image translation and image flipping relatively belongs to the weak data, and otherwise the data that is changed in hue and colors relatively belongs to the strong data.

When the student model 22 is trained by the unlabeled data 25, the strong data augmented strategy is applied for learning the unlabeled data 25 based on the pseudo labels generated by the teacher model 21 (203). In the exemplary diagram shown in FIG. 2, the student model 22 introduces the labeled data 26 (205). In addition to the labeled data 26, the student model 22 also learns the combination of the labeled data 26 and the unlabeled data 25 and the pseudo labels being generated based on the prediction results so as to achieve the purpose of the teacher model 21 guiding the student model 22. The performance of the student model 22 can be improved when the student model 22 completes the learning process.

Subsequently, the teacher model 21 relies on a soft label filter 27 to filter out low-quality pseudo labels based on the pseudo label filtering strategy (207) and obtains high-quality pseudo labels. The pseudo labels that are filtered out by the soft label filter 27 and the prediction results (209) obtained by the student model 22 based on the unlabeled data 25 and the labeled data 26 are outputted to a positive sample loss module 28 that operates a positive sample loss function. Therefore, negative impacts caused in the above training process due to incomplete information of the pseudo labels can be solved. Finally, a backward propagation process (211) that applies an exponential moving average (EMA) method is used to update the teacher model 21 (213), and then both the teacher model 21 and the student model 22 can operate under a same architecture.

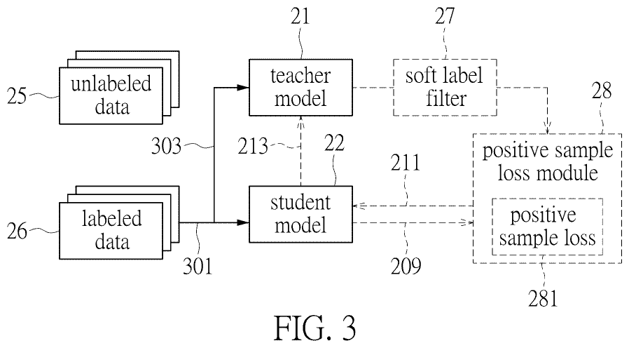

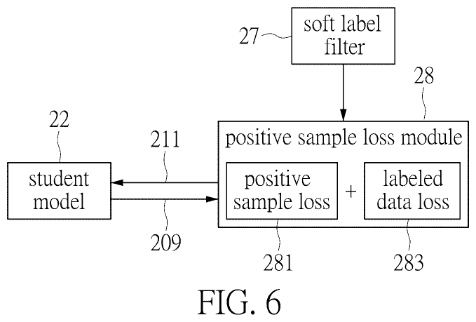

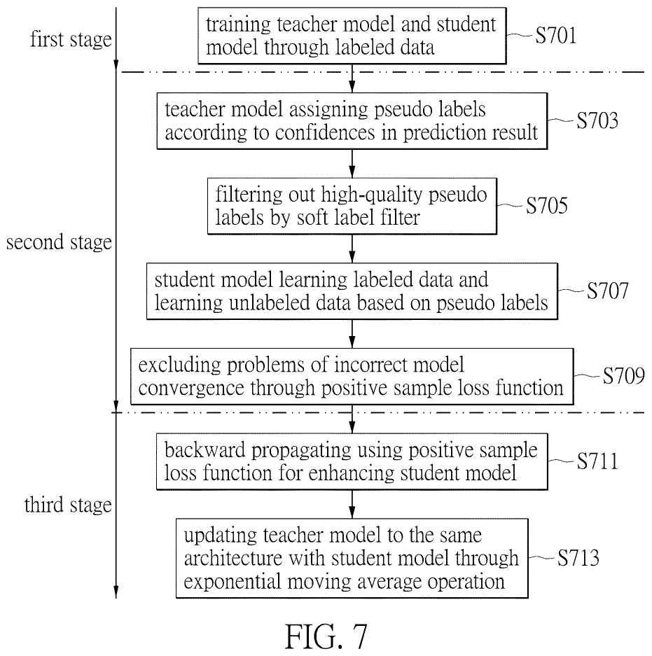

The system that operates the three-stage semi-supervised instance segmentation training method adopts asymmetric teacher-student model architecture. According to one embodiment of the present disclosure, the above training process can be divided into three stages. References are made to FIG. 3 through FIG. 5, which respectively illustrate processes of the three stages; reference is also made to FIG. 6, which is a schematic diagram depicting operations of the positive sample loss module, and further reference is made to FIG. 7, which is a flowchart illustrating the three-stage semi-supervised instance segmentation training method according to certain embodiments of the present disclosure.

In the three-stage semi-supervised instance segmentation training method, a more complex teacher model that a learning capacity of the teacher model is improved for allowing the teacher model to learn more precisely at a first stage and a second stage. The student model can be taught more precisely at the second stage. The asymmetric architecture of the teacher model and the student model is adopted in the system at both the first stage and the second stage for training the student model. The teacher model 21 and the student model 22 can be operated under different architectures. In other words, parameters such as number of layers and channels of the models under a same model design can be referred to for obtaining models of different scales. Accordingly, the same model types with different precisions or the different model types with different precisions can be obtained. At a third stage, the teacher model 21 and the student model 22 are synchronized to be the same architecture.

It should be noted that the conventional semi-supervised training method applies the exponential moving average method in the training process for updating the teacher model. However, since the conventional exponential moving average method requires both of the teacher model and the student model to have the same model architecture and capacity (i.e., complexity), the conventional semi-supervised instance segmentation training method cannot be adapted to the teacher model having a larger capacity. Therefore, the three-stage semi-supervised instance segmentation training method is provided. In the method, there is no restriction that the teacher model and the student model must have the same capacity since the training process does not use the exponential moving average method. Thus, the teacher model having a larger capacity can be trained so that the precision thereof will be enhanced.

Reference is made to FIG. 3, which is a flowchart illustrating the first stage process in the three-stage semi-supervised instance segmentation training method according to one embodiment of the present disclosure. The characteristics in an initial training process are as follows. Unlike the conventional semi-supervised training method that requires the exponential moving average to update the teacher model 21 (213), the teacher model 21 is more flexible in selection at the first stage. For example, the teacher model 21 having different architecture and capacity from the student model 22 can be selected, which means that the teacher model 21 having more capacity can be used in an initial training state. The asymmetric teacher model 21 and the student model 22 can be trained through the labeled data 26 for enhancing the student model 22.

The teacher model 21 and the student model 22 are respectively trained through different quality of data. In an exemplary example, a high-quality data 303 can be firstly retrieved from the labeled data 26 and provided for training the teacher model 21. Therefore, the teacher model 21 can learn more features even if it is under limited circumstances for enhancing performance of the teacher model 21 and subsequently generating high-quality pseudo labels. On the other hand, low-quality data can otherwise be obtained from the labeled data 26 (301). These data are provided for training the student model 22 (step S701 of FIG. 7).

In one of the embodiments of the present disclosure, for the purpose of image processing, the teacher model 21 and the student model 22 adopt different scaling training strategies. For example, the teacher model 21 can be trained by high-resolution images provided from the labeled data 26. It should be noted that the higher resolution data can provide more features and more learnable details for enhancing performance of the teacher model 21 and generating high-quality pseudo labels. For training the student model 22, the images can be magnified for repeatedly generating the prediction results and enhancing accuracy of mask prediction so as to strengthen reliability of the models. Therefore, the student model 22 can also be enhanced in the training process. Relatively, the student model 22 can be trained by lower-resolution images provided from the labeled data 26. According to the above-mentioned scaling training strategies, the teacher model 21 and the student model 22 respectively learn different qualities of labeled data 26 until both the teacher model 21 and the student model 22 reach a stable state. After that, the student model 22 can provide the prediction results that are generated based on learning the labeled data 26 to the positive sample loss module 28 for calculating positive sample losses (209).

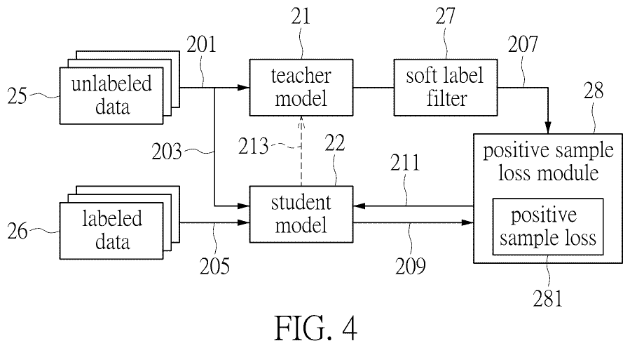

The above-described first stage illustrates a process of transiting from the models being trained by the labeled data 26 to the unlabeled data 25. Since the training process at the first stage will suffer from decline in accuracy, a second stage illustrated in FIG. 4 is therefore provided.

At the second stage, the asymmetric teacher-student architecture is also adopted for training the student model. Both the above-described unlabeled data and pseudo labels can be used as the training dataset for the student model at the second stage. One of the purposes of the second stage is to use the labeled data 26 and the pseudo labels generated by the teacher model 21 to train the student model 22. The teacher model 21 conducts prediction on the unlabeled data 25 and then assigns pseudo labels to the unlabeled data according to the confidences of the prediction results (step S703 of FIG. 7). The soft label filter 27 is used for filtering out the high-quality pseudo labels by present confidence thresholds (step S705 of FIG. 7). The pseudo labels are then provided for the student model 22 to learn the unlabeled data 25 based on the pseudo labels in addition to learning the labeled data 26 (step S707 of FIG. 7).

Further, when using the unlabeled data 25 to train the teacher model 21, a weak data augmented strategy is incorporated for the teacher model 21 to learn images that are not substantially changed (201). Still further, when using the unlabeled data 25 to train the student model 22, a strong data augmented strategy is incorporated for the student model 22 to learn images that are significantly changed. This approach makes a final performance of the student model 22 greater than the teacher model 21.

It should be noted that a deep-learning method requires that prediction of assignments should one-by-one correspond to actual labels, However, the semi-supervised learning process may encounter problems with label loss, and label loss will result in incorrect assignment of the prediction results. Accordingly, in the three-stage semi-supervised instance segmentation training method of the present disclosure, when the teacher model 21 and the student model 22 are trained, there are some negative impacts on the models since some object predictions will be incorrectly determined based on the pseudo labels generated from the unlabeled data 25. In the meantime, referring to the prediction results of the student model 22, the positive sample loss function in the positive sample loss module 28 can be used to deal with the problems of incomplete information in the pseudo labels (209). For example, a class loss can be used to calculate a positive sample loss 281 that can prevent the models from converging toward a wrong direction. Afterwards, a backward propagation process (211) can update the student model 22 in the training process according to errors calculated from the positive sample loss 281.

Therefore, the three-stage semi-supervised instance segmentation training method of the present disclosure applies the positive sample loss method for allowing the models to focus on the prediction results with actual correspondence. In other words, the positive sample loss method allows an assignment task to focus on the positive samples for preventing the negative impacts to the training process from incorrect assignment due to incomplete pseudo labels, so that the training effectiveness of the student model can be enhanced.

FIG. 6 is a schematic diagram depicting the positive sample loss module 28 in the three-stage semi-supervised instance segmentation training method according to one embodiment of the present disclosure. As described above, it is necessary for the positive sample loss module 28 to calculate the positive sample loss 281. In one further embodiment of the present disclosure, when the prediction results generated by the student model 22 with a certain level training achievement are outputted to the positive sample loss module 28, the positive sample loss function is performed to classify the data and calculate the positive sample losses of the labeled data 26 and the unlabeled data 25. Further, the labeled data and the unlabeled data are referred to in addition for classifying the data for obtaining the positive sample loss 281 and a labeled data loss 283. Therefore, the problem of incorrect model convergence due to the pseudo labels with incomplete information can be eliminated from the pseudo labels filtered out by the soft label filter 27, so that the prediction accuracy of the model can be enhanced (step S709 of FIG. 7). Thus, the performance of the model can be enhanced by optimizing the model parameters.

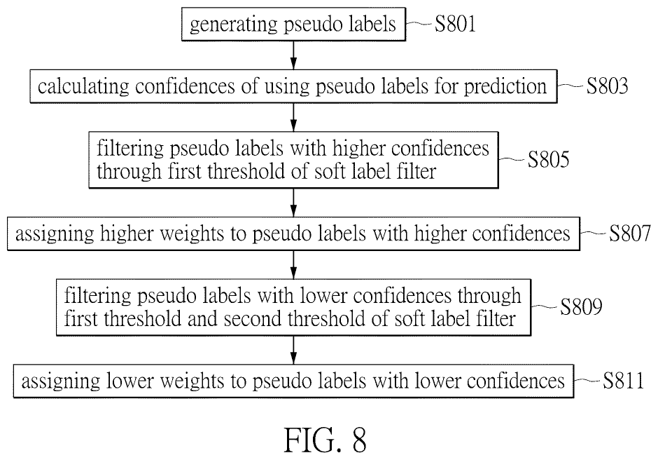

For the step S705 of FIG. 7, in one of the embodiments of the present disclosure, for allowing the teacher model 21 to provide reliable pseudo labels to the student model 22, the soft label filter 27 is used to filter for obtaining the high-quality pseudo labels. The soft label filter uses two different thresholds to classify two types of pseudo labels. The different types of the filtered pseudo labels are assigned with different weights so as to avoid wasting too much information. Reference can be made to FIG. 8, which is a flowchart illustrating an operating process of the soft label filter 27 according to one embodiment of the present disclosure.

Reference is made to FIG. 8, which is a flowchart illustrating a process of filtering the pseudo labels in the three-stage semi-supervised instance segmentation training method according to one embodiment of the present disclosure. In the beginning, the teacher model 21 generates the pseudo labels (step S801) and calculates confidences in the data predicted by using each of the pseudo labels (step S803). In one of the embodiments of the present disclosure, unlike the conventional technology that only uses one threshold to classify available and unavailable pseudo labels, provided in three-stage semi-supervised instance segmentation training method of the present disclosure is the soft label filter 27 that uses two thresholds (i.e., a first threshold and a second threshold) based on the calculated confidences to assign different degrees of weights to the pseudo labels. The weights assigned to the pseudo labels allow the data having a higher confidence to be strengthened and prevent discarding too much unlabeled data 25.

Based on the confidences of the pseudo labels, the soft label filter relies on the first threshold to filter for obtaining the pseudo labels with higher confidences (step S805). The pseudo labels with the higher confidence can be assigned with a higher first weight (step S807). Next, the soft label filter relies on the first threshold and the second threshold to filter out the pseudo labels with lower confidences that are between the first threshold and the second threshold (i.e., the confidences lower than the first threshold but greater than the second threshold) (step S809). Thus, the pseudo labels with lower confidences are assigned with a lower second weight (step S811). The second weight is a kind of soft level weight that can effectively use more data for training the models more efficiently. In addition, the pseudo labels with the confidences lower than the second threshold can be discarded.

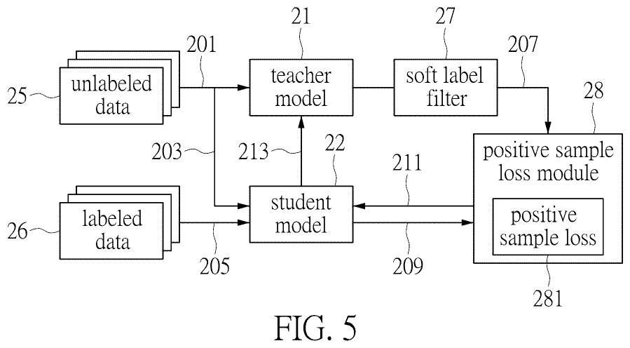

Next, FIG. 5 is a flowchart illustrating a third stage process in the three-stage semi-supervised instance segmentation training method according to one embodiment of the present disclosure. At the third stage, the teacher model is configured to be updated to be the same architecture and the same capacity with the student model. An exponential moving average method is introduced in between the teacher model 21 and the student model 22 to update the teacher model 21 (213), that is, to use the results of the trained student model 22 to gradually update the teacher model 21 until both the teacher model 21 and the student model 22 reach a stable state.

When the positive sample loss module 28 is used to obtain the parameters for optimizing the model, the backward propagation process (211) is configured to update the parameters of the student model 22 (step S711 of FIG. 7), by which the student model 22 can be optimized. When the student model 22 has been trained to be a model with better performance, the information (e.g., the weights) inside the student model 22 can be used to update the teacher model 21 through an exponential moving average (EMA) operation. Accordingly, the teacher model 21 and the student model 22 can be with the same algorithm and weights (step S713 of FIG. 7). It should be noted that the weights denote connectivity strength between an input layer and an output layer of a neural network. It is worth noting that, at the third stage, stability of the models in an updating process can still be ensured since the information learned by the student model 22 with a better learning efficiency can be gradually updated to the teacher model 21.

It is also worth noting that the above-described process is a continuous training process that applies the exponential moving average operation to continuously update the information of the student model 22 to the teacher model 21 (213). Therefore, the stability of models to be trained should be maintained in an initial stage until reaching a stable state. Further, the efficiency of the teacher model 21 can be ensured to be better than the student model 22 in the training process, and decline of performance of the teacher model 21 and the student model 22 can be avoided when the accuracy declines.

The three-stage semi-supervised instance segmentation training method of the present disclosure can ensure high-quality pseudo labels and sufficiently use both the labeled data and the unlabeled data to effectively enhance accuracy of mask prediction so as to train a high-performance deep-learning model under a convolutional neural model framework.

Equations 1 to 4 depict an exemplary example of calculation of a positive sample loss function used in the three-stage semi-supervised instance segmentation training method of the present disclosure.

Equation 1 depicts a positive sample loss function “L” that consists of a positive sample loss “Lₗ” of the labeled data and a positive sample loss

$$“ {L}_{u}^{ps} ”$$

of the unlabeled data in the three-stage semi-supervised instance segmentation training method. The positive sample loss

$$“ {L}_{u}^{ps} ”$$

of the unlabeled data is multiplied by a weighting coefficient “λᵤ” to obtain a weighted positive sample loss

$$“ {λ}_{u} {L}_{u}^{ps} ”$$

of the unlabeled data.

$$L = {L}_{1} + {λ}_{u} {L}_{u}^{ps} . \qquad Equation 1$$

In Equation 2, the positive sample loss “Lₗ” of the labeled data consists of three loss functions including a bounding box loss function “L_{b}” with a weighting coefficient “λ_{b}”, a mask loss function “Lₘ” with a weighting coefficient “λₘ” and a class loss function “L_{c}” with a weight coefficient “λ_{c}” with respect to different tasks. The weighting coefficients (i.e., “λ_{b}”, “λₘ” and “λ_{c}”) can be adjusted based on requirements of applications of the models. Further, the variables “mᵢ”, “bᵢ” and “cᵢ” are labels of ground truth for the above three loss functions, and the variables “\tilde{m}ᵢ”, “\tilde{b}ᵢ” and “\tilde{c}ᵢ” denote the prediction results (e.g., probability values). The positive sample loss “Lₗ” of the labeled data obtained in Equation 2 indicates a weighted sum of the positive sample losses obtained from the three different tasks such as the above-mentioned bounding box, mask and class in the instance segmentation training method. It should be noted that, when the positive sample losses of the bounding box and the mask are calculated, only the losses of positive samples “i=0˜pos” are calculated. One of the objectives in the instance segmentation training process is to speed up a calculation time by only considering the prediction results being consistent with the ground truth.

$${L}_{1} = {\sum }_{i = 0}^{pos} {λ}_{b} {L}_{b} ( {\tilde{b}}_{i} , {b}_{i} ) + {λ}_{m} {L}_{m} ( {\tilde{m}}_{i} , {m}_{i} ) + Σ {λ}_{c} {L}_{c} ( {\tilde{c}}_{i} , {c}_{i} ) . \qquad Equation 2$$

Equation 3 is essentially the same as Equation 2, and Equation 3 can be regarded as a variant of Equation 2. Equation 3 shows the positive sample loss

$$“ {L}_{u}^{ps} ”$$

of the unlabeled data and the positive sample loss

$$“ {L}_{u}^{ps} ”$$

is used to deal with a condition with actual labels. The variables “ [symbol] ”, “\tilde{m}ᵢ” and “\tilde{c}ᵢ” with respect to the positive sample loss function “L_{b}” for bounding box, the positive sample loss function “Lₘ” for mask, and the positive sample loss function “L_{c}” for class denote the prediction results, and the variables “ [symbol] ” and [symbol] denote the pseudo labels. Further, the weighting coefficients “λ_{bu}”, “λₘᵤ” and “λ_{cu}” respectively represent the weighting coefficients of the bounding box “b”, the mask “m” and the class “c” for the unlabeled data with a subscript “u.” Further, the weighting coefficient “λₘᵤ” for the mask unlabeled data is configured to be slightly lower for preventing the model from overfitting to an inaccurate boundary too quickly.

$${L}_{u}^{ps} = {\sum }_{i = 0}^{pos} {λ}_{bu} {L}_{b} ( {\tilde{b}}_{i} , {\hat{b}}_{i} ) + {λ}_{mu} {L}_{m} ( {\tilde{m}}_{i} , {\hat{m}}_{i} ) + {λ}_{cu} {L}_{c} ( {\tilde{c}}_{i} , {\hat{c}}_{i} ) . \qquad Equation 3$$

Equation 4 depicts conditions for selecting the weighting coefficient “λᵤ” representing the weighting coefficients “λ_{bu}”, “λₘᵤ” and “λₘᵤ” of the unlabeled data in the above tasks. A variable “Cᵢ” denotes a confidence of a pseudo label, and variables “tₕ” and “tₗ” respectively denote two confidence thresholds for the soft label filter. Thus, a higher weighting coefficient “α” is assigned to the pseudo label when its confidence is higher than the higher confidence threshold “tₕ”, and a lower weighting coefficient “decay*α”, namely a decay coefficient, is assigned to the pseudo label when its confidence is between the higher confidence threshold “tₕ” and the lower confidence threshold “tₗ.” As the above-described embodiments, only the pseudo labels having the confidences higher than the lower confidence threshold are involved for calculation of the positive sample loss function. Therefore, the negative impacts due to the inaccurate pseudo labels can be reduced.

$${λ}_{mu} = \{ \begin{matrix}α , if {C}_{i} \geq {t}_{h} ; \\ decay * α , else if {t}_{h} \geq {C}_{i} \geq {t}_{1} ; \\ 0 , otherwise .\end{matrix} \qquad Equation 4$$

In conclusion, the above-described embodiments of the three-stage semi-supervised instance segmentation training method relate to solutions for enhancing precision of the model that is trained by the unlabeled data. More specifically, the asymmetric teacher-student model architecture is applied for gradually updating the information learned by the student model to the teacher model, and the performance of both of the teacher model and the student model can be improved together. Therefore, the conventional restriction that the architectures of the teacher model and the student model should be kept consistent and the problem of high training cost can be solved. Further, the soft label filter introduced in the training process uses two or more different thresholds to obtain the pseudo labels with different weights for avoiding wasting too much information. The positive sample loss function is also introduced in the training method for preventing the negative impacts to the training process due to incomplete information of the pseudo labels. Accordingly, a convolutional neural network (CNN) framework deep-learning model can be efficiently trained.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A three-stage semi-supervised instance segmentation training method, comprising:
at a first stage, training a teacher model and a student model through labeled data for making the teacher model and the student model reach a stable state, wherein the teacher model and the student model are respectively trained by different qualities of data;
at a second stage, the teacher model performing prediction on unlabeled data, assigning pseudo labels to the unlabeled data according to a confidence with respect to a prediction result, providing the pseudo labels to the student model, making the student model learn the labeled data, and learning the unlabeled data based on the pseudo labels; and
at a third stage, updating parameters of the student model to the teacher model.

2. The method according to claim 1, wherein, at the first stage and the second stage, according to a scaling training strategy, the teacher model learns high-resolution pictures so as to generate reliable pseudo labels.

3. The method according to claim 1, wherein the parameters of the student model are weights and an exponential moving average operation is incorporated to update the student model to be the teacher model through the weights.

4. The method according to claim 1, wherein, at the second stage, the unlabeled data and the pseudo label form a training data used to train the student model, a positive sample loss function is performed to classify the data and calculate positive sample losses of the labeled data and the unlabeled data for eliminating a problem of incorrect model convergence due to the pseudo labels with incomplete information; and the student model is updated according to errors calculated from the positive sample losses through a backward propagation process.

5. The method according to claim 1, wherein, at the second stage, a soft label filter is used to filter for obtaining high-quality pseudo labels.

6. The method according to claim 5, wherein the soft label filter employs a first threshold and a second threshold, by which a first weight is assigned to the data with the pseudo labels having confidences greater than the first threshold, a second weight is assigned to the data with the pseudo labels having confidences between the first threshold and the second threshold, and the data with the pseudo labels having confidences less than the second threshold is discarded.

7. The method according to claim 6, wherein, at the first stage and the second stage, according to a scaling training strategy, the teacher model learns high-resolution pictures so as to generate reliable pseudo labels.

8. The method according to claim 1, wherein asymmetric teacher-student model architecture allows the teacher model and the student model to have a same model type with different precisions, or different model types with different precisions.

9. The method according to claim 8, wherein, at the first stage and the second stage, according to a scaling training strategy, the teacher model learns high-resolution pictures so as to generate reliable pseudo labels.

10. The method according to claim 9, wherein, when using the unlabeled data to train the teacher model, a weak data augmented strategy is incorporated to learn images that are not substantially changed, and, when using the unlabeled data to train the student model, a strong data augmented strategy is incorporated to learn images that are significantly changed so as to make a final performance of the student model greater than the teacher model.

11. A system operating a three-stage semi-supervised instance segmentation training method, comprising:
a computing device, using a computing circuit to perform the three-stage semi-supervised instance segmentation training method comprising:
at a first stage, training a teacher model and a student model through labeled data for making the teacher model and the student model reach a stable state, wherein the teacher model and the student model are respectively trained by different qualities of data;
at a second stage, the teacher model performing prediction on unlabeled data, assigning pseudo labels to the unlabeled data according to a confidence with respect to a prediction result, providing the pseudo labels to the student model, making the student model learn the labeled data, and learning the unlabeled data based on the pseudo labels; and
at a third stage, updating parameters of the student model to the teacher model.

12. The system according to claim 11, wherein, at the first stage and the second stage, according to a scaling training strategy, the teacher model learns high-resolution pictures so as to generate reliable pseudo labels.

13. The system according to claim 11, wherein the parameters of the student model are weights and an exponential moving average operation is incorporated to update the student model to be the teacher through the weights.

14. The system according to claim 11, wherein a positive sample loss function is performed for classifying the data into the labeled data and the unlabeled data for calculating the positive sample losses so as to eliminate a problem of incorrect model convergence due to the pseudo labels with incomplete information.

15. The system according to claim 11, wherein, at the second stage, a soft label filter is used to filter for obtaining high-quality pseudo labels.

16. The system according to claim 15, wherein the soft label filter employs a first threshold and a second threshold, by which a first weight is assigned to the data with the pseudo labels having confidences greater than the first threshold, a second weight is assigned to the data with the pseudo labels having confidences between the first threshold and the second threshold, and the data with the pseudo labels having confidences less than the second threshold is discarded.

17. The system according to claim 16, wherein, at the first stage and the second stage, according to a scaling training strategy, the teacher model learns high-resolution pictures so as to generate reliable pseudo labels.

18. The system according to claim 11, wherein the system adopts asymmetric teacher-student model architecture that allows the teacher model and the student model to have a same model type with different precisions, or different model types with different precisions.

19. The system according to claim 18, wherein, at the first stage and the second stage, according to a scaling training strategy, the teacher model learns high-resolution pictures so as to generate reliable pseudo labels.

20. The system according to claim 19, wherein, when using the unlabeled data to train the teacher model, a weak data augmented strategy is incorporated to learn images that are not substantially changed, and, when using the unlabeled data to train the student model, a strong data augmented strategy is incorporated to learn images that are significantly changed so as to make a final performance of the student model greater than the teacher model.
